(19) United States
(12) Patent Application Publication
(10) Pub. No.: US 2026/0362138 A1
(43) Pub. Date: Nov. 12, 2026

(54) Adaptive Home Security System Tailored for Remote Workers

(71) Applicant: Siu Ming Sherman POON, Hong Kong (HK)

(72) Inventor: Siu Ming Sherman POON, Hong Kong (HK)

(21) Appl. No.: 19/200,808

(22) Filed: May 7, 2025

(51) Int. Cl. H04W 12/08; H04W 12/06

(52) U.S. Cl. CPC H04W 12/08; H04W 12/06

(57) ABSTRACT

A method and system for certifying the security of home offices for remote workers is provided. The system includes a certification server configured to receive a request for certification from a remote worker and to perform a series of security checks on the remote worker's home office environment. The security checks include ensuring that IoT devices, patch routers, laptops, webcams, wireless access points, and mobile devices in the home office are properly secured and isolated on a separate network, verifying the implementation of administrative security measures such as password policies, access controls, and security training, and using geolocation data to define a boundary around the remote worker's home office. The system generates a certification report indicating the level of security of the home office and provides the report to the remote worker.

### FIELD OF INVENTION

The present disclosure relates to the field of communications media, and, more particularly, to remote systems and related methods.

### BACKGROUND OF THE INVENTION

With the rise of remote work, it has become increasingly important to ensure the security of home offices where confidential work is being conducted. Cybersecurity measures are often the focus of remote work security, but physical and administrative security are equally important. Remote workers may not have access to the same physical security measures as they would in a traditional office environment, and administrative security measures such as access controls and security training may be overlooked. Additionally, remote workers may be located in areas that are more vulnerable to physical security threats, such as theft, burglary, or vandalism.

Remote work and the use of IoT devices have become increasingly prevalent in recent years. The trend towards remote work accelerated, with many organizations transitioning to a fully remote or hybrid work model. While working from home offers many benefits, including increased flexibility and reduced overhead costs for organizations, it also presents unique security challenges.

Remote workers may not have access to the same physical security measures as they would in a traditional office environment, and administrative security measures such as access controls and security training may be overlooked. There is also a risk that IoT devices used in the home office environment may not be properly secured, leaving them vulnerable to cyber attacks and other security breaches. Additionally, remote workers may be located in areas that are more vulnerable to physical security threats, such as theft, burglary, or vandalism.

### SUMMARY OF THE INVENTION

The present invention provides a system and method for certifying the security of home offices for remote workers. The system includes a certification server that performs a series of security checks on the home office environment to ensure that physical and administrative security measures are in place. The system also uses geolocation data to define a boundary around the remote worker's home office, which can help to identify potential physical security threats and vulnerabilities in the surrounding area. A certification device is also included in the system to enforce the geolocation boundary around the remote worker's home office.

### BRIEF DESCRIPTION OF DRAWINGS

FIG. 1 is a graphical diagram representing an embodiment of a home office certification web server system according to the present disclosure.

FIG. 2 is a flowchart representing an exemplary embodiment of a process for directing certification device specific requests to a home computing device browser as implemented by the system of FIG. 1.

FIG. 3 is a flowchart representing an exemplary process of compliance certification of household members according to the present disclosure.

FIG. 4 is a graphical diagram representing an embodiment of a cloud workspace portal according to the present disclosure.

FIG. 5 is a flowchart representing an exemplary process of ensuring isolation of IoT devices according to the present disclosure.

FIG. 6 is a flow diagram representing an embodiment of an application-based cloud workspace server system according to the present disclosure.

FIG. 7 is a flowchart representing an exemplary process of compliance certification retrieval according to the present disclosure.

FIG. 8 is a flowchart representing an exemplary process of ensuring home office network infrastructure meet the required security standards according to the present disclosure.

### DETAILED DESCRIPTION OF THE INVENTION

The system for certifying the security of home offices for remote workers includes a certification web server, a mobile application, a database for storing certification reports, a history tracker for storing and tracking the history of security checks, and a certification device for enforcing home network boundaries around the remote worker's home office. The certification web server is configured to receive a request for certification from the remote worker, perform a series of security checks on the home office environment, and generate a certification report indicating the level of security of the home office. The mobile application allows the remote worker to submit the request for certification and to receive the certification report. The database is used to store the certification reports generated by the certification web server.

The present invention is characterized by its exceptional adaptability, designed to cater to diverse user requirements through the support of a range of off-the-shelf safety and security standards. This versatility enables users to tailor their security solutions based on individual needs. The security checks performed by the certification web server are designed to ensure that physical and administrative security measures are in place and that all devices in the home office environment are properly secured. The security checks can be customized based on specific requirements or guidelines provided by the remote worker or the organization they work for. In addition to the security checks described above, the certification web server also defines a boundary around the remote worker's home office. This boundary can be used to identify potential physical security threats and vulnerabilities in the surrounding area. The certification report generated by the certification web server provides an overview of the level of security of the home office environment, including any potential physical security threats identified using the home network boundary data.

For those adhering to a Remote Worker Safety Standard, the invention aligns with standard security devices to offer robust protection in a home office setting. This includes, but is not limited to, common VPN-enabled routers, consumer Wi-Fi routers with advanced patch management capabilities, basic intrusion detection software, keyless entry smart locks, conventional indoor security cameras, standard uninterruptible power supplies (UPS), readily available smart thermostats, consumer-grade indoor air quality sensors, and simple-to-install occupancy sensors to detect the presence or absence within the workspace. The system includes checks to verify the operational status and proper configuration of these devices, ensuring they are updated with the latest security patches and firmware, thereby preventing unauthorized access and cyber threats, while also securing physical access to the home office.

Furthermore, security checks can be tailored to the selected safety and security standards by incorporating alternative device types. This can include biometric security locks for enhanced physical access control, consumer-level firewall appliances for robust network protection, portable emergency alert buttons for personal safety in various settings, energy-efficient backup power solutions to ensure uninterrupted work during power outages, and multi-sensor smoke detectors for comprehensive environmental monitoring, thus ensuring the system's compliance with a broad spectrum of safety and security needs.

The history tracker component of the system stores and tracks the history of security checks, providing a record of the security status of the home office environment over time. The system also includes a certification device for enforcing the home network boundaries around the remote worker's home office. The certification device can be configured to send alerts to the certification web server or to the remote worker's mobile application if the boundary is breached. This can help to identify potential physical security threats and vulnerabilities in the surrounding area and can alert the remote worker to take appropriate action.

The certification device provides remote network access to a remote worker's corporate network. Instead of using a VPN, it utilizes a cloud browser running on cloud workspaces. The cloud browser is launched within a Docker container and streamed to the remote worker's browser. After the session, the browser and the cloud workspace are deleted, ensuring security. A Chrome browser extension can be installed to specify a Uniform Resource Locator (URL) associated with the cloud workspace and choose a default workspace image.

The system offers secure browsing within the cloud workspace, ensuring privacy and security. No browsing activity, key logs, screen recordings, or telemetry data are collected. Load-balanced servers enhance the system's performance and reliability.

The cloud browser operates within a cloud workspace, which is a virtual environment hosted remotely. When the certification device is plugged into a home computing device such as a laptop, the cloud browser is streamed from the cloud workspace to the remote worker's local browser. This means that the actual browser execution occurs in the cloud, not on the local machine. As a result, even if the home computer is compromised or infected, the cloud browser remains secure because it is running remotely within the protected cloud workspace.

The cloud workspace, which includes the cloud browser, is isolated from the local machine. Any malware or malicious activity that may occur within the cloud browser does not impact the remote worker's home computer. The cloud workspace provides a contained and separate environment for browsing activities, ensuring that any potential threats or compromises are limited to the cloud workspace and do not spread to the home computing device.

Once the remote worker finishes their browsing session, the cloud browser and the entire cloud workspace are deleted. This ensures that any malware or compromised elements within the cloud browser are completely eradicated. By terminating the session and deleting the workspace, no traces of the browsing activity or any potential threats remain on the local machine. This enhances security and reduces the risk of persisting malware or data breaches.

By utilizing the cloud browser and workspaces, the attack surface and vulnerability of the local machine are significantly reduced. The home computer is not directly exposed to potential threats or compromises that can occur during browsing activities. This separation helps to protect the remote worker's device, data, and network from various security risks associated with traditional browsing methods.

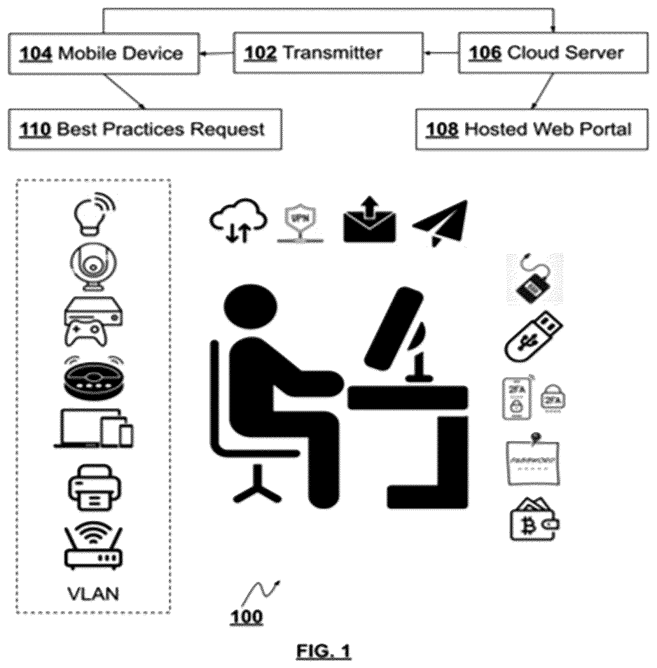

Referring to FIG. 1, an exemplary embodiment of a system 100 as disclosed herein may include a certification device 102 that is configured to support some or all of broadcast options including without limitation short-range Bluetooth technology. Broadcast messages from any one or more of a plurality of certification devices may be transmitted to proximate home computing devices 104 such as for example phones, tablets or the like, wherein such devices are capable of receiving the broadcast messages. A certification web server 106 is further communicatively linked to the device 104 or otherwise accessible via a communications network. The server 106 is configured to direct a browser or application of the home computing device 104 to content via for example a Zero-Trust URL 110, with the content corresponding to a particular certification device 102 being designated in various embodiments by an administrator or the like via a cloud workspace portal 108 in association with the certification web server 106.

In an embodiment, a system 100 as disclosed herein may incorporate a functionality in the cloud workspace portal that translates a certification device's fixed Uniform Resource Identifier (URI) into a desired URL link. As but one example, if certification device 102 with identifier #AkfGGy is directed to point to a cloud browser with the Zero-Trust URL of www.Xyz.com, a user simply goes to the cloud workspace portal 108 which enables the user to launch a cloud browser via the Zero-Trust URL www.Xyz.com.

In one example of a typical certification device operation, when a user with a home computing device 104 selects the cloud browser, the browser will automatically link to a cloud browser 110 associated with the Zero-Trust URL as was entered in the cloud workspace portal by the certification device's administrator. Typically, the Zero-Trust URL may be associated with a third-party assessor organization (3PAO) website.

In certain embodiments, other data may be embedded in the initial URL as broadcast by the certification device via information tags. The server 106 may process these information tags in accordance with instructions and provide the certification device administrator information via the cloud workspace portal 108. The cloud workspace portal may identify a cloud browser 110 to be returned to the browser from among a plurality of options based on the contextual information provided via the URL-embedded information tags. In embodiments wherein the cloud workspace portal is also the content server, it may populate certain content upon user selection of the associated Zero-Trust URL 110 with different information based on the contextual information provided via the URL-embedded information tags.

Regarding the cybersecurity awareness and certification of household members who reside in the same location as the remote worker's home office, since they share the same proximity and network environment, their online activities can have an impact on the overall security of the home office and potentially pose a threat vector. In such cases, it is beneficial to extend the certification and training efforts to include household members.

The certification report generated for the remote worker includes an aggregate assessment of the household's cybersecurity awareness. This can be achieved by evaluating the cybersecurity practices and knowledge of all household members who utilize the home network. The assessment may cover areas such as password management, safe browsing habits, software updates, and awareness of social engineering attacks.

By determining a household cybersecurity awareness rating, the report can identify any gaps or vulnerabilities within the household. Red flags can be raised if certain household members exhibit lower levels of cybersecurity awareness or engage in risky online behaviors.

Including household members in cybersecurity awareness and training efforts is crucial for ensuring the overall security of the home office environment. By extending certification and training to household members, organizations can create a more comprehensive and resilient security posture. By identifying any gaps or vulnerabilities within the household, organizations can tailor training programs to address specific areas of concern.

Incorporating the household's cybersecurity awareness into the certification report allows for a holistic view of the security status. It provides valuable insights into the overall security posture, identifies potential weak points, and highlights areas that require additional attention or training. This information can guide targeted efforts to improve cybersecurity practices within the household and mitigate the risk of security incidents.

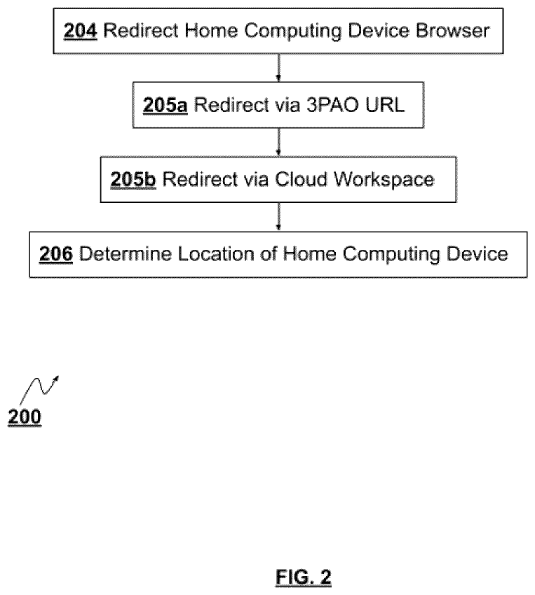

Referring next to FIG. 2, an exemplary method 200 as disclosed herein for providing a more complete abstraction of certification device hardware from the need for any physical interaction.

In an embodiment, the host server may receive and process certain information in the content request in accordance with analytical information and associated content to be designated in step 204.

The method 200 may continue with step 204 wherein the host server directs the home computing device browser to content designated for the respective certification device in the form of a Zero-Trust URL. In an embodiment, the server may determine content in association with a device application as opposed to a browser, wherein the content designated is to be populated in the home computing device application.

In relevant embodiments, the server may determine the Zero-Trust URL designated for the unique certification device based in part on the additional informational tags included in the content request. The server may further append or include information tags to the determined Zero-Trust URL based in part on designated inputs from the certification device administrator via the cloud workspace portal. For example, the server may direct the home computing device browser or application to presentation of the Zero-Trust URL in accordance with satisfaction of administrator-designated threshold parameters as further may be determined by the home computing device browser or application itself, based on tags including without limitation: user identity, household members, etc.

The method 200 may continue with step 205, wherein the host server may direct the device browser to the designated content via a third-party URL (205a) or alternatively via a cloud workspace portal (205b). In step 205a, the server may redirect to content hosted via a third-party, which will be identified by its URL. In certain embodiments, the server may generate a third-party URL including URL tags such as the certification device ID, a home computing device supplied user ID, or queries by which the third party assessor organization (3PAO) website can process information and display content in association with the content designation of the server upon the home computing device. Alternatively, in step 205 b, the server may provide an Zero-Trust URL associated with a hosted content server, wherein the device browser may be selectably redirected to hosted content thereby.

The method 200 may continue with step 206 wherein the host server is configured to determine a location of the home computing device as proximate to one or more of the networked certification devices. This step may be distinguished from a determination of distance from a particular certification device, or a direction from the home computing device to said certification device, but rather relates to a determination that the home computing device and by extension an associated user is physically present in proximity with said certification device. Accordingly, the host server is able to provide positive confirmation, for example to the certification device administrator or simply for internal analytics, that the person accessing the cloud browser is in near proximity to that certification device at that particular time, as opposed to general access as may be obtained from any Internet connected device regardless of location or for example at a later time. In an embodiment, this presence detection function is also based upon the host's ability to positively identify its certification devices by their keyed pairing with their cloud server.

Regarding the inclusion of occasional visitors such as friends who visit the remote home office from time to time, as these individuals may have access to the home office environment and its network, their presence can introduce additional security risks.

In the certification process and report, it is important to consider the potential presence of visitors and their impact on security. This is hard to address. Hard to assess visitor's awareness of cybersecurity best practices and their adherence to any guidelines or restrictions when accessing the home office environment, because it is impractical to not let visitors into your home just for security reasons. Home office is not a corporate office after all. Physical security is harder to enforce.

To enhance security measures, automatic alerts can be implemented to notify both the remote worker and the corporate entity when visitors connect to the home office network. These alerts can serve as a proactive measure to ensure that any potential risks are promptly identified and appropriate actions can be taken.

Additionally, automatic safeguards can be put in place to mitigate security concerns. For example, access to the protected Wi-Fi network within the home office environment can be restricted to authorized devices only. Any visitors can be directed to use a separate guest.

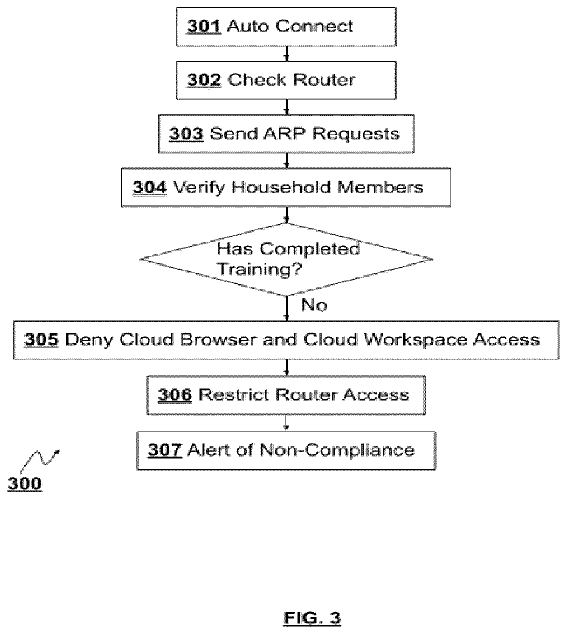

Referring now to an exemplary process 300 for certification devices as illustrated in FIG. 3, a certification device may be configured to scan for household members who are non-compliant with the corporate standard. At step 301, a certification device automatically detects and connects to a preconfigured home Wi-Fi network. The certification device accesses the corporate standard and actionable best practices published in the cloud on the internet. The certification device acts as a security checkpoint by checking its connected home wifi router for compliance against the remote worker's corporate standard and actionable best practices 302. At step 303, The certification device uses Python packet crafting to send ARP requests to discover all hosts in the local subnet, including all devices connected to the same network, for compliance with the corporate standard, verifying factors such as up-to-date software, firewall settings, and anti-malware protection. At step 304, the certification device identifies the household members based on the list previously reported by the remote worker, compares the identified household members against the corporate compliance training records to ensure they have received sufficient training. The certification device denies cloud browser and cloud workspace access if one or more household members are discovered to have not completed the required corporate compliance training, which puts the household in non-compliance 305. At step 306, The certification device communicates with the home Wi-Fi router to enforce the access restriction, preventing the other devices from connecting to the cloud browser and cloud workspace. The certification device displays a notification or error message on the remote worker's home computing device, explaining that household members do not meet corporate compliance standards, and therefore, cloud browser and cloud workspace are disallowed 307.

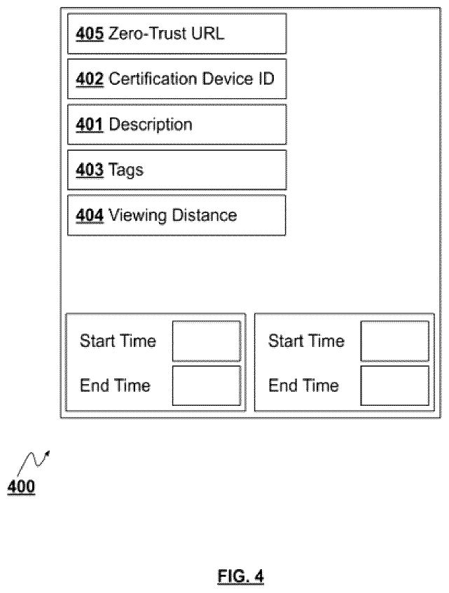

By utilizing systems and methods as disclosed herein, and with further reference to FIG. 4, one can set the desired viewing range by simply checking a box indicating at an administrative cloud workspace portal 400. This is the same portal where the Zero-Trust URL 405 may be set. The cloud workspace portal might work for example where a certification device having ID #Ah8unT 402 is pointed toward Zero-Trust URL http://demo-url.com and has a designated viewing distance 404 of “IMMEDIATE”, which would cause one to see this URL on a cloud browser if one is within a certain proximity, such as for example about approximately three feet of the certification device 102.

By using this method, the administrator is not adjusting the transmit power of the certification device, but instead is passing back to the viewing browser the range at which it should make the website (in the coded message #8NJHRF) available for user selection, such that the browser, which can measure range because of its ability to monitor the certification device's signal strength, can then make use of this preference to decide whether to display the website, or alternately, how to rank it on the browser display.

One additional benefit of this approach is that the cloud workspace portal will also allow one to set up and pre-designate alternate destination web pages for a certification device and simply swap between them, or to automatically swap between them according to a predetermined schedule.

In another aspect, various embodiments of a system and method as disclosed herein may provide additional service enhancements when one makes use of a certification web server to enhance, translate and augment the information broadcast by a physical certification device. For example, in one embodiment a user may manage cloud browser metadata (e.g., pertaining to favicons, titles, descriptions and the like) at the host server level. The host server could return these selections to the browser in place of the metadata embedded in the destination web site, thus allowing the administrator to make easy changes to the information that will appear on the inspector's search display to describe the cloud browser.

As another example, a user selectable corporate identifier (e.g., query variable “phycorporateID”) may be appended to for example a source identifier or the like. Certification device owners may accordingly be able to choose a corporate identifier variable to be appended to content messages associated with all certification devices designated as being associated with a corporate, so that they can quickly track those accesses that come through the cloud workspace server.

As yet another example, the cloud workspace server may be configured to automatically generate a unique conformance statement variable (e.g., “phystatementID”) for each access. Accordingly, when the variable is required to be validated against the unique transaction identifier, the certification device owner may be assured that the conformance statement can only be used by inspectors who were actually present. In an exemplary embodiment, the system in accordance with each instance of the URL being accessed with a unique conformance statement variable will be able to display that unique conformance statement code, and owners will be able to know how many codes were issued and redeemed.

In accordance with various embodiments as disclosed herein, the web browser may be configured to append information to the URL received from the certification device to be interpreted and acted upon by the cloud workspace portal. The appended information may include one or more variables for adding contextual information about the certification device scanning event. For example, appended variables may include a unique inspector identifier, an application identifier, user-selected preferences, and the like.

By appending browser-based variables, the certification device can send contextual information unique to the transaction to the cloud workspace portal, enabling greater intelligence in retrieving and returning personalized content. Whereas the URL from the certification device identifies a user's location and proximity, certification device variables identify the user and the user's selected preferences. This allows the cloud workspace portal to determine not only the user's proximity to a given certification device and query content based upon that interaction, the cloud workspace portal can also add all of this information to the Zero-Trust URL so as to allow the customization that content based on user preferences set in the certification device application. Variables added to the content broadcast by a certification device during the interval when that transaction is handled by a browser, as opposed to variables added at the level of the certification device or at the level of the cloud workspace server, are particularly valuable for their ability to identify the user of the app and the user's preferences, whereupon this information may be used by the cloud workspace portal to determine the content returned to the inspector, or these variables may be appended to the Zero-Trust URL for further processing by a different content management system.

The cloud workspace portal directs the certification device to or otherwise makes available for user selection a content server associated with the certification device URL and in accordance with any instructions provided via the browser-based suffix string. In certain embodiments, the cloud workspace portal may retrieve the Zero-Trust URL associated with the certification device URL component of the received URL and then append query variables onto the Zero-Trust URL, and these appended query variables may be the variables added by the browser, thus transferring them to the content server. These embodiments are advantageous in part because when the Zero-Trust URL is shared by the user with other individuals, the unique query variables are retained, allowing the cloud workspace portal to track how, when, by whom, and in some cases to whom the information was shared.

In some embodiments, information retrieval may be performed by the certification device in association with a combination of certification device URL information and user preferences. For example, the certification device may cache information in advance based upon predefined or heuristic instructions, such as where a user frequents certain certification devices or when proximity to one certification device instructs the application to cache certain information. This form of caching may be particularly useful where Internet access is spotty, weak, or nonexistent. For example, for a user who goes through an area with poor data signal, the certification device may cache certain content associated with one or more certification devices and in accordance with the specifications selected at the preliminary certification device. In said example, the certification device may cache information in advance and to be retrieved at certain certification devices placed throughout the inspection where internet access is known to be good. By caching this information, the certification device may return content based upon subsequent certification device proximities without having to send and retrieve information to and from the cloud workspace server.

In an embodiment, a proprietary certification device may enable a user to access certain secure or private content associated with the proprietary certification device and not others. In this manner, users browsing via specific applications may be able to receive unique content not accessible to other certification devices of a different type. For example, users of a corporate application may be able to receive content such as internal policies or procedures not accessible to users of a generic certification device. Because the URLs of certification devices are universally available, the same certification device message broadcast could return different content to an open browser than to a proprietary browser.

Proprietary browsers further allow for various types of Physical Web applications beyond dynamic web content access. In certain embodiments, the certification device may append a security key in addition to other variables. The appended key may be the same security key associated with the certification device or may be an independent key. For example, the security key may be appended in association with a particular user who has used login credentials with the certification device. Inclusion and detection of this key may enable the cloud workspace portal to return secured content. For example, a proprietary browser and key may enable an authorized user to access content not available to users accessing the same certification devices without a security key. This content may be further secured by making the key single-use, such that copies of the information sent by the secure browser will not also return the private content a second time. In another example, a security guard may be able to check into locations automatically by walking near specific certification devices with the proprietary browser enabled. Alternatively, depending upon the number of characters required to implement security, the security key may be transmitted in alternate broadcast from the sensor data to allow both to be transmitted.

Actionable best practices generally provide guidance on recommended configurations and settings rather than providing specific executable scripts. However, depending on the organization's technical capabilities and requirements, the implementation of these best practices may involve the use of executable scripts or automation tools to configure home Wi-Fi network settings, device settings, VLANs, and other aspects of network security.

Executable scripts can be helpful in automating the deployment and configuration of security measures across multiple devices or networks. For example, a script could be used to configure Wi-Fi network settings with strong encryption, change default passwords on network devices, or implement VLAN segmentation.

Executable scripts can be used to ensure conformity to a corporate baseline or predefined security standards. These scripts can automate the configuration and enforcement of specific security settings across devices and systems within an organization. By running these scripts, organizations can efficiently and consistently enforce security measures and maintain a standardized security posture.

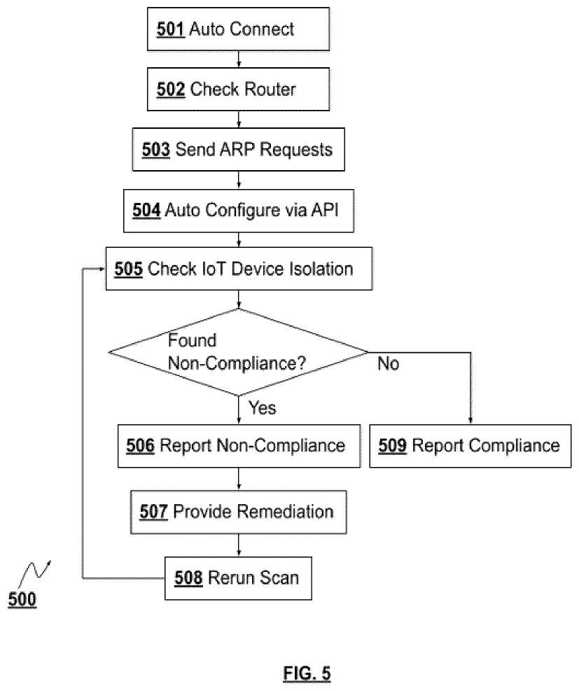

Referring now to an exemplary process 500 for certification devices as illustrated in FIG. 5, a certification device may be configured to scan for isolation of IoT devices on a VLAN. At step 501, a certification device automatically detects and connects to a preconfigured home Wi-Fi network. The certification device accesses the corporate standard and actionable best practices published in the cloud on the internet. The certification device acts as a security checkpoint by checking its connected home wifi router for compliance against the remote worker's corporate standard and actionable best practices 502. At step 503, the certification device uses Python packet crafting to send ARP requests to discover all hosts in the local subnet, including all devices connected to the same network, for compliance with the corporate standard, verifying factors such as up-to-date software, firewall settings, and anti-malware protection. The certification device uses an API to configure devices on the network and automate network configuration and automation 504. At step 505, the certification device checks for IoT devices that are not isolated on a VLAN. The certification device reports non-compliance to the certification web server if one or more IoT devices are discovered to be not isolated on a VLAN 506. At step 507, the certification web server provides guidance on recommended configurations and settings to remediate the non-compliance. The certification device uses executable scripts to configure the IoT device settings and VLANs to meet the recommended configurations and settings. The certification device reruns the security scan to ensure that the IoT device is now properly isolated on a VLAN 508. The certification device reports the compliance status of the IoT device to the certification web server 509.

The certification device mandates that users report a list of household members. The certification device then records this information on the corporate server and cross-checks it against a list of detected device inventory on the connected home network. The certification device identifies connected devices and prompts the user to specify the household owner of each device. It then verifies that each identified device is patched and compliant with corporate standards.

The certification device will deny corporate network access via the cloud browser or cloud workspace if there are unidentified devices on the home network or if any household owners lack sufficient corporate compliance training. If there are unidentified devices due to guests or visitors, the certification device may take action based on corporate compliance actionable best practices. In some cases, it may disallow corporate network access, the cloud browser, and cloud workspace until the visit is over and the unidentified devices are no longer on the home network. In other cases, the certification device may require the user to identify all unidentified devices belonging to guests, create a guest VLAN to isolate them, and then allow corporate network access to the cloud browser and cloud workspaces while keeping them isolated from the guest VLAN.

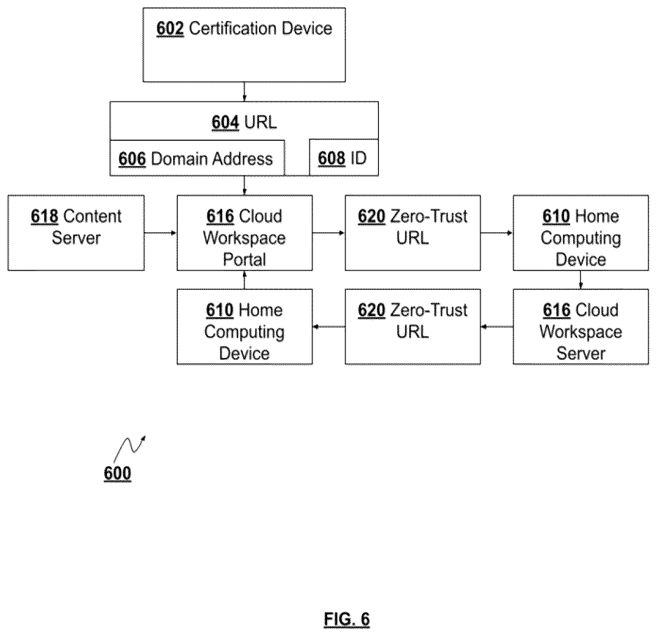

Referring to FIG. 6, an exemplary embodiment of a system 600 as disclosed herein may include a certification device 602 configured to broadcast a URL 604. The URL 604 may comprise at least a domain address component 606 and a unique certification device ID 608, wherein the certification device ID 608 is a unique identifier for the associated certification device 602. The URL 604 may comprise an access protocol and cloud workspace server (e.g. http://YYY.net) as the domain address component 606 and a PhyID (e.g. “ABC123”) as the certification device ID 608, such that in combination the two form a complete URL (e.g. http://YYY.net/ABC123).

In response to a content request from a device, the cloud workspace portal 616 generates a Zero-Trust URL 620, with the appended contextual variables, for the determined content on the content server 618 and delivers that Zero-Trust URL to the home computing device 610. The home computing device 610 may submit a plurality of content requests to the cloud workspace server 616 where for example broadcasts from numerous certification devices have been received by the device with respect to a single location. In this case, the cloud workspace server 616 may return one or more Zero-Trust URLs 620 to the device 610 in accordance with the plurality of content requests. The Zero-Trust URLs 620 may be presented via the device as a selectable list of content options, in the common form of an internet search display, wherein upon selection of any one particular content option, content may be accessed from the respective content server for that Zero-Trust URL. Accordingly, the browser or application on the home computing device 610 receives contextually specific content via the Zero-Trust URL 620 in reference to the proximate certification device 602.

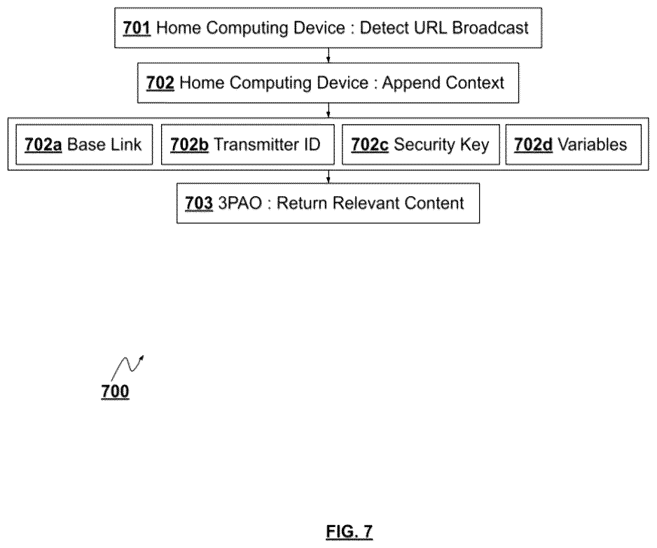

Referring now to FIG. 7, an exemplary method 700 as disclosed herein may be characterized in part wherein a home computing device is configured to perform step 701 wherein the home computing device detects a URL broadcast by a certification device. The home computing device may detect the URL broadcast via one or more various sensors such as proximity-based wireless protocols such as Bluetooth, and the like, the home computing device sufficiently proximate to the certification device to detect the broadcast.

The method 700 may further be characterized in part by the step 702, wherein the home computing device, via an associated browser or application, appends zero, one, or more variables to the received URL in accordance with software instructions therein, thereby generating an appended URL. In some embodiments, the appended variables may embody contextual information about the home computing device or client state, or device user wherein the certification device URL transmits information pertinent to the certification device in the URL and the home computing device appends device-based information such as user settings, user input, device state, software state, and proximity to the certification device.

The method 700 may further be characterized in part by step 705, wherein a hosted content server or 3PAO content server may use the components identified in step 704 to return more relevant content to the home computing device. In one embodiment, the cloud workspace portal may internally process certain components while appending or embedding other components with respect to a Zero-Trust URL, wherein the appended variables may provide delimitations for the content server as to a subset of the associated content. In embodiments wherein the cloud workspace portal is the content server, the cloud workspace portal may use the appended variables to help determine an arrangement of content compatible for display via the stated browser. In some embodiments, the cloud workspace portal may process certain components and/or variables irrespective of the content to be retrieved, wherein such components and/or variables provide non-content-based information such as metrics.

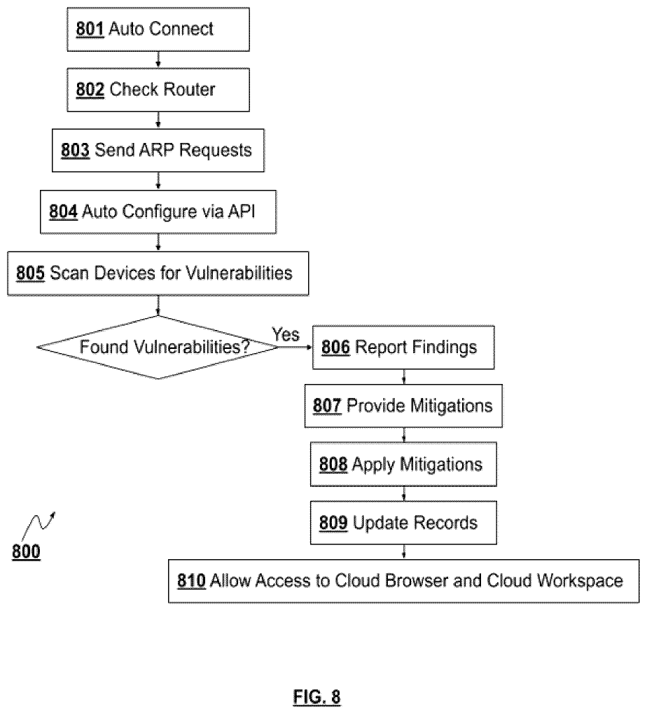

Referring now to an exemplary process 800 for certification devices as illustrated in FIG. 8, a certification device may be configured to scan for vulnerable devices on a home network. At step 801, a certification device automatically detects and connects to a preconfigured home Wi-Fi network. The certification device accesses the corporate standard and actionable best practices published in the cloud on the internet. The certification device acts as a security checkpoint by checking its connected home wifi router for compliance against the remote worker's corporate standard and actionable best practices 802. At step 803, the certification device uses Python packet crafting to send ARP requests to discover all hosts in the local subnet, including all devices connected to the same network, for compliance with the corporate standard, verifying factors such as up-to-date software, firewall settings, and anti-malware protection. The certification device uses an API to configure devices on the network and automate network configuration and automation 804. At step 805, the certification device scans devices for known exploits, runs a list of known exploits against target devices to confirm vulnerabilities. The certification device reports findings to the certification web server in the cloud if one or more target devices are found to be indeed vulnerable to a known exploit, such as a discontinued webcam or security camera 806. At step 807, the certification web server checks its database for available patches or mitigations for the identified vulnerability, and sends them to the certification device if patches or mitigations are available. The certification device applies the patches or mitigations to the target device 808. The certification device reruns the security scan to ensure that the vulnerability has been properly addressed. The certification device reports the compliance status of the IoT device to the certification web server. The certification web server updates its records to reflect the new compliance status of the target device if the vulnerability is successfully mitigated 809. The certification device launches the cloud browser and cloud workspaces, allowing the remote worker to access the corporate network and work within the cloud workspace, ensuring secure browsing and privacy 810. Once the user is done, the cloud workspace and browsing session are terminated, and the certification device deletes the cloud workspace and browser, ensuring no data is left behind.

1. A system for certifying the security of home office networks adaptable to various safety and security standards based on the needs of a remote worker and household members previously reported by the remote worker, comprising:
a plurality of certification devices, each of said certification devices configured to broadcast wireless messages comprising a Zero-Trust Uniform Resource Locator (URL) associated with a cloud workspace and an identifier for the respective certification device; and
one or more certification servers configured to:
receive a request for certification from the plurality of certification devices, the certification server being further configured to perform a series of security checks on the home office environment according to selected safety and security standards,
generate a certification report indicating the level of compliance with the selected safety and security standards of the home office,
generate a cloud browser enabling designation by an authorized user of content to be accessed by home computing devices proximate the respective certification device, and
responsive to a content request from a home computing device comprising the Zero-Trust URL and the identifier for the respective certification device, to provide access via the cloud browser executed by the home computing device to content designated for the respective certification device according to the selected safety and security standards;
wherein the security checks for non-compliance of the home office networks connecting the plurality of certification devices comprise:
determining the configuration of Wi-Fi routers connected to the home office networks against selected safety and security standards;
determining the isolation of IoT devices connected to the home office networks based on the selected standard;
assessing, against corporate compliance training records obtained by the one or more certification servers, the sufficiency of corporate compliance training received by the remote worker and household members according to the selected standards;
identifying and managing unidentified guest devices connected to the home office networks; and
the plurality of certification devices using execution scripts to communicate with the Wi-Fi routers to:
implement guest VLAN segmentation if unidentified guest devices are determined, and
deny access to the cloud browser and workspaces if non-compliance with the selected safety and security standards is determined.

2. The system of claim 1, wherein each of said certification devices is further configured to generate a different unique identifier for each broadcasted message, further wherein the one or more certification servers are configured to:
authenticate one or more certification devices in accordance with a content request from a home computing device comprising respective ones of said unique identifiers, and
responsive to the authentication of the one or more certification devices, to provide access via the cloud browser to the designated content.

3. The system of claim 2, wherein the cloud workspace portal enables designation by an authorized user of content to be accessed by home computing devices in accordance with a Zero-Trust URL, and wherein the one or more certification servers are configured to provide access to content designated for the respective certification device by generating a message to the home computing device including the Zero-Trust URL.

4. The system of claim 3, wherein the one or more certification servers are further configured to process one or more information tags appended to the Zero-Trust URL in the content request, and to include one or more of the information tags to the Zero-Trust URL in the generated message to the home computing device.

5. The system of claim 3, wherein the one or more certification servers are further configured to enable an administrator via the cloud workspace portal to define a proximity setting and one or more information tags, wherein the one or more certification servers are configured to provide access to content designated for the respective certification device by generating the message to the home computing device including the proximity setting and the one or more information tags with the Zero-Trust URL.

6. The system of claim 5, wherein the one or more certification servers are further configured to enable an administrative user via the cloud workspace portal to set up and pre-designate alternate destination safety and security standards for a certification device and simply swap between them, or to automatically swap between them according to a predetermined schedule.

7. The system of claim 6, wherein access to the content is provided via one or more of a cloud workspace portal and redirection of the executed browser to a third party URL designated via the cloud workspace portal.

8. The system of claim 6, wherein the content request comprises a first request from the home computing device, and wherein the one or more certification servers are configured, responsive to authentication of the certification devices associated with the first request, to coordinate with a cloud browser executed by the home computing device to generate selectable options associated with content designated for the authenticated certification devices in accordance with the respective proximity settings and information tags, and responsive to a second request from the home computing device associated with an option selection, to provide access via the cloud browser to the respectively designated safety and security standards.

9. The system of claim 8, wherein the option selection comprises a hyperlink associated with the third party URL, and compliance information associated with the third party URL, and the cloud workspace generated by the one or more servers for the authorized user further enables dynamic adjustments to the compliance information associated with the third party.

10. The system of claim 3, wherein the one or more certification servers are further configured, responsive to authentication of a certification device associated with the first request, to generate a broadcasting URL to the cloud browser comprising the Zero-Trust URL and the unique identifier for the certification device.
